(19) United States
(12) Patent Application Publication
(10) Pub. No.: US 2010/0183053 A1
(43) Pub. Date: Jul. 22, 2010

(54) SYSTEM AND APPARATUS FOR DATA TRANSMISSION

(76) Inventors: DUKE H. TRAN, Huntington Beach, CA (US); Shing-Hong Lin, Redondo Beach, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/356,456

(22) Filed: Jan. 20, 2009

(51) Int. Cl. H04B 1/38; H04L 27/00

(52) U.S. Cl. 375/219; 375/295; 375/316

(57) ABSTRACT

A system for data transmission, comprises a transmitter and a receiver in communication, wherein the transmitter is configured to receive a first data signal; encode information contained in the first data signal in a second data signal; and transmit the second data signal to the receiver; and wherein the receiver is configured to: receive the second data signal; decode information contained in the second data signal; wherein the second data signal is encoded with binary information, having: a first state of the binary data comprising a waveform with a duty cycle strictly between 50% and 100%; and a second state of the binary data comprising a waveform with a duty cycle strictly between 0% and 50%.

### TECHNICAL FIELD

The present invention relates to communication networks, and more particularly, some embodiments relate to noise-tolerant signal transcoders.

### DESCRIPTION OF THE RELATED ART

As is well known in the art, time division multiplexing (TDM) comprises incorporating a plurality of incoming channels into one outgoing channel. In TDM, each incoming channel alternates or takes turns for a certain amount of time in the outgoing channel. For example, two signals A₁A₂A₃A₄ . . . and B₁B₂B₃B₄ . . . , where each Nᵢ represents a block of data, may be time division multiplexed together to form the single signal A₁B₁A₂B₂A₃B₃4₄ . . . . However, TDM is not normally preffered for full duplex exchange of data along a single channel or line. Therefore, TDM may be inadequate for some communication applications between data producing and data receiving systems that require the ability to handshake. As is well known in the art, a serializer/deserializer (SerDes) may be used to provide full duplex data exchange. A SerDes is similar to a TDM system with the addition of full duplex data exchange. A SerDes may be used in situations where handshaking is desired. However, both TDM and SerDes have inherent speed limitations and require complex design to accommodate the transmission of a high bandwidth multi-format signal. For example, transmission of high definition audiovisual data using a TDM or SerDes system is complex and expensive.

In optical fiber communications, wavelength division multiplexing (WDM) may be used to transmit multiple signals along a single optical line. WDM comprises assigning each incoming channel its own separate wavelength of light and transmitting the separate wavelengths through a single fiber simultaneously. This also allows for two-way communication along a single optical fiber. However, WDM systems that are not specially adapted to audiovisual data communication are usually too expensive to use in an audiovisual application, while WDM systems that are specifically adapted to audiovisual data communication usually fail to provide for the transmission of auxiliary audio or data signals.

### BRIEF SUMMARY OF EMBODIMENTS OF THE INVENTION

According to various embodiments of the invention, a system and apparatus for data transmission are presented. The system and method enable multiplexing a plurality of multi-format data signals into a combined signal. The combined signal is conditioned for optical transmission and transmitted in a fiber optic system. The combined signal is received and demultiplexed back into the plurality of data signals. The signals are provided through an interface.

According to an embodiment of the invention, a system for data transmission comprises a transmitter and a receiver in communication, wherein the transmitter is configured to receive a first data signal; encode information contained in the first data signal in a second data signal; and transmit the second data signal to the receiver; and wherein the receiver is configured to: receive the second data signal; decode information contained in the second data signal; wherein the second data signal is encoded with binary information, having: a first state of the binary data comprising a waveform with a duty cycle strictly between 50% and 100%; and a second state of the binary data comprising a waveform with a duty cycle strictly between 0% and 50%.

According to further embodiment of the invention, the first state comprises a waveform having a duty cycle between approximately 65% and approximately 85% and the second state comprises a waveform having a duty cycle between approximately 15% and 35%.

According to another embodiment of the invention, a system for data transmission, comprises a transmitter and a receiver in communication, wherein the transmitter is configured to receive a first data signal; encode information contained in the first data signal in a second data signal; and transmit the second data signal to the receiver; and wherein the receiver is configured to receive the second data signal; decode information contained in the second data signal; wherein the second data signal is encoded with binary information, having a first state of the binary data comprising a waveform with a duty cycle strictly between 50% and 100%; and a second state of the binary data comprising a waveform with a duty cycle strictly between 0% and 50%.

According to a further embodiment of the invention, the transmitter is further configured to receive a plurality of high bandwidth data signals; receive a plurality of low bandwidth data signals; receive a clock signal; combine the plurality of low bandwidth data signals and the clock signal to form the first data signal; and transmit the plurality of high bandwidth data signals to the receiver; and wherein the receiver is further configured to receive the plurality of high bandwidth data signals and wherein the decoding comprises recovering the clock signal and the plurality of low bandwidth data signals.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 depicts an embodiment of the invention deployed in an example environment.

FIG. 2 depicts an example transmitting module 65 that may be configured to receive a data signal from a data source through an interface, transcode the data signal, and transmit the transcoded data signal through a fiber optic cable.

FIG. 3 depicts an example receiving module configured to receive a wavelength multiplexed encoded signal from a transmitter, to demultiplex and decode the signal into a plurality of signals and to provide the signals through an interface.

FIG. 4A represents a functional block diagram of an example implementation of the present invention in a transmitting capacity.

FIG. 4B represents a functional block diagram of an example implementation of the present invention in a receiving capacity.

FIG. 5A represents a functional block diagram of an example implementation of the invention in a transmitting capacity.

FIG. 5B represents an example implementation of the invention in a receiving capacity.

FIG. 6 represents a flow chart of an example method of the current invention in a transmitting capacity.

FIG. 7 represents a flow chart of an example implementation of the invention in a receiving capacity.

FIG. 8 illustrates an example of a line code transcoding function.

FIG. 9 illustrates a portion of an example input signal and an example portion output transcoded signal for comparison purposes.

FIG. 10 represents a computing module with which various aspects or features of the invention might be implemented.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

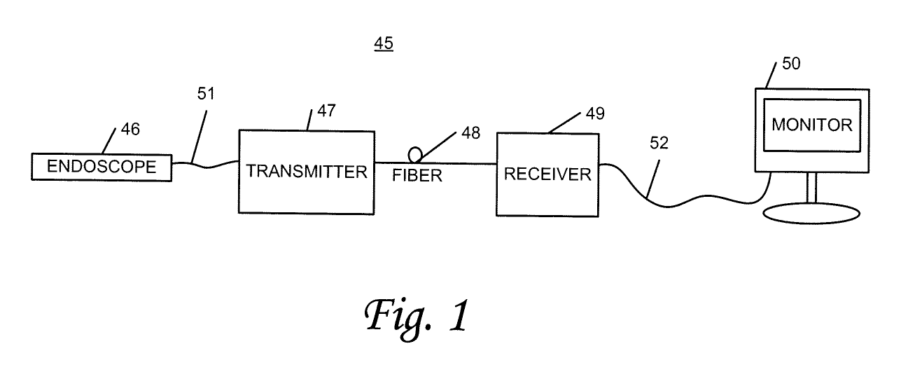

Before describing the invention in detail, it is useful to describe a few example environments in which the invention can be implemented. One such example is that of a high definition video transmission system for medical applications. FIG. 1 depicts an example embodiment of the invention in this environment. FIG. 1 depicts an example embodiment of the invention linking a medical device with a monitor. Transmission system 45 may be implemented as a communication link between a data producing device such as endoscope 46 and a data display device such as monitor 50.

In this example implementation, endoscope 46 may be connected to transmitter 47 using a digital data cable 51, and monitor 50 may be connected to receiver 49 using a digital data cable 52. In this example, digital data cables 51 and 52 utilize a digital data interface, such as, for example: a high definition multimedia interface (HDMI); a digital video interface accompanied by an auxiliary data cable for non-video signals; or a display port (DP) interface. In some examples, transmission system 45 may utilize a different interface for cable 51 and cable 52. In which case, transmission 45 may also serve as a converter. Transmitter 47 and receiver 49 may be in communication through an optical fiber 48, and may be configured to allow the exchange of data between the monitor 50 and the endoscope 46, where data exchanged between the monitor and endoscope is not modified by the transmitter and receiver. In this example, all data sent by the endoscope 46 is received by the monitor 50 without apparent modification, while all data sent by the monitor 50 is received by the endoscope 47 without apparent modification. In other words, computer systems in endoscope 46 or monitor 50 can not detect that the monitor and endoscope are not simply connected by one long digital data cable.

From time-to-time, the present invention is described herein in terms of this example environment. Description in terms of this environment is provided to allow the various features and embodiments of the invention to be portrayed in the context of an exemplary application. After reading this description, it will become apparent to one of ordinary skill in the art how the invention can be implemented in different and alternative environments.

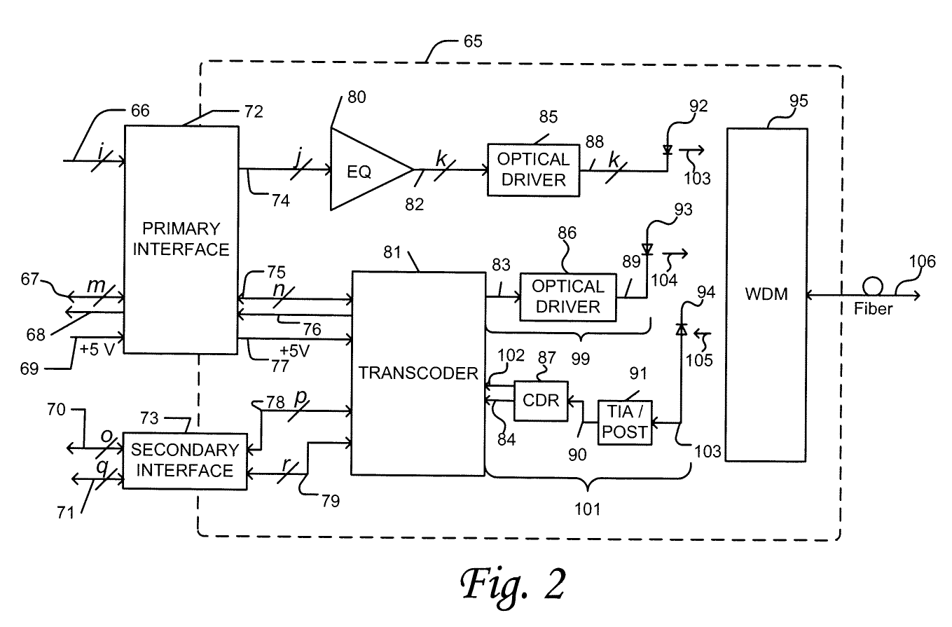

Referring now to FIG. 2, FIG. 2 depicts an example transmitting module 65 that may be configured to receive a data signal from a data source through an interface, transcode the data signal, and transmit the transcoded data signal through a fiber optic cable. In some examples, transmitting module 65 may comprise a primary interface module 72 designed to accept a plurality of data signals through a standard interface. For example, the interface module 72 may interface using, for example: a high definition multimedia interface (HDMI); a digital video interface (DVI); or a display port (DP) interface. In an example utilizing a DVI interface, the primary interface module 72 may be configured to receive: a plurality of four high-definition video and clock channels 66; data channels 67, such as, for DVI, display data channel (DDC) data; a hot plug detect channel 68; and a +5V power channel 69. Transmitter 65 may also include a secondary interface 73 configured to receive, for example, auxiliary audio channels 70, and auxiliary data channels 71. In these examples, video channels 66 may be of a high bandwidth of approximately 2.7 gigabits per second, while channels 67, 68, 69, 70, and 71 may be of lower bandwidth; for example, approximately 50 megabits per second combined.

Although only one primary interface block 72 is shown, further examples could accommodate a plurality of different interfaces, such as an HDMI, a DVI, a Display Port, a USB interface, and so on. In these examples, the primary interface 72 may have a variety of input connector ports, each configured to receive a different input connector. This interface may be further configured to accommodate this plurality of input sources by transmitting utilizing only a subset of available internal channels. For example, in a black and white application, the number i of video channels 66 may be less than the number required for a color signal. The number j of video channels 74 may be configured to accommodate a color video signal. Therefore, in this example, the primary interface 72 may be configured to utilize only i of the j available channels 74. As a further example, in a digital video using DVI application, the number m of non-video channels 67 may be two, a DDC data channel and a DDC clock channel. However, the number n of internal non-video channels 75 may be more than two, for example. n might also include channels to accommodate an HDMI signal having a consumer electronics control channel and a digital rights management channel. In this case, the primary interface 72 would provide the DVI channels to an available subset of the n internal non-video channels.

Referring still to FIG. 2, video signals carried on plurality of i input lines 66 are transmitted through primary interface module 72 and carried on plurality of video channels 74. Video channels 74 may be coupled an equalizer 80 if needed to compensate for losses from longer cable length. Equalizer 80 may be chosen to match the intended input. For example in a DVI application, equalizer 80 may comprise an 8 dB equalizer. In examples configured to accommodate a plurality of different signal types, a corresponding plurality of different equalizers 80 may be chosen as needed. Thus, by utilizing multiple connector ports and multiple appropriate equalizers (as needed), the example system can handle multiple signal types.

Signals carried on channels 82 may then be transferred to an optical driver 85 to enable fiber optic transmissions. For example, optical driver 85 may be a laser driver configured to provide a driven signal appropriate for conversion into a laser signal by a diode, such as a VCSEL laser diode. Driven signals carried on channels 88 are then transmitted through laser or light emitting diodes 92 and wavelength division multiplexing (WDM) multiplexer/demultiplexer 95 for signal transmission along optical fiber 96. In some examples, light or laser emitting diodes 92 may comprise laser diodes such as VCSEL laser diodes. WDM requires a different wavelength of light for each signal. In some examples, each of k light or laser emitting diodes 92 emits a different wavelength, allowing signals on each of the k channels to have their own wavelength. In other examples, the k light or laser emitting diodes 92 may each emit approximately the same wavelength. In these examples, a plurality of optical filters (not shown), such as tunable optical filters, may be employed to provide each of the k signals with its own wavelength of light. WDM 95 may comprise an apparatus for combining multiple wavelengths of light for transmission along one optical fiber. For example, WDM 95 may comprise an arrayed waveguide grating. WDM 95 may then transmit the combined signals along an optical fiber 106, such as a singlemode or multimode optical fiber.

Simultaneously, signals carried by the non-video channels 67, 68, 70, and 71 are passed through primary interface module 72 and secondary interface module 73 into transcoding module 81. For example, in an DVI application: m non-video channels 67 may comprise a DDC data channel and a DDC clock channel; non-video channel 68 may comprise a hot plug detect channel; o non-video channels 70 may comprise auxiliary audio channels; and q non-video channels 71 may comprise auxiliary data channels. In an HDMI application: m non-video channels 67 may comprise an additional CEC control channel, a content protection channel, and digital audio channels; the non-video channels 71 may be configured to carry analog audio; and the non-video channels 671 may carry q auxiliary data channels.

Transcoding module 81 may be configured to receive signals from the plurality of non-video channels and to combine them into an outgoing signal carried on channel 83. Transcoding module 81 may also be configured to provide incoming signals carried on channel 84 to the interfaces 72 and 73. For example, hot plug detect channel 68 may be configured to carry an incoming signal that transcoding module 81 is configured to decode from incoming signals carried on channel 84. As another example, data channels 71 may be outgoing and incoming data channels. In which case, transcoding module 81 may be configured to encode the outgoing signals from the outgoing channels into outgoing signal 83 and decode the incoming signals from the incoming channels 84.

In some systems, the passage of incoming signals through circuit portion 101 may interfere with outgoing signals through outgoing circuit portion 99. In which case, transcoding module 81 may be configured to encode the outgoing signal carried on channel 83 so that crosstalk interference between transmitting portions 99 and receiving portions 101 does not prevent data decoding and clock signal recovery by a corresponding receiving transcoding module (not shown). Outgoing signals on channel 83 may then be passed through optical driver 86 to enable optical transmission. Driven outgoing signal channel 89 is then transmitted through optical fiber 106 using laser or light emitting diode 93 and WDM 95, as described above regarding the transmitted video signals.

Transmitter 65 may be further configured to receive an incoming signal on incoming signal channel 101. An incoming signal 105 may arrive through fiber 106 and be demultiplexed by WDM 95 and converted into an electrical signal using receiving photodiode 94. For example, an arrayed waveguide filter may be used for demultiplexing, while a tuned optical filter may be used to isolate the wavelength presented to the receiving photodiode 94. The received signal may then be converted into a voltage modulated signal, for example through the use of a transimpedance amplifier (TIA) 91. The voltage modulated incoming signal carried on channel 90 is then passed through a clock recovery module 87, which operates to recover a clock signal 102 and a data signal 84 from the incoming signal, for example, using a phase lock loop or a digital phase lock loop. The clock signal is carried on channel 102 and the data signal is carried on channel 84 and are then provided to transcoding module 81. Transcoding module 81 may be configured to decode the data signal using the clock signal into a plurality of incoming signals, for example, through time division demultiplexing. Decoded incoming channels may then be provided either through primary interface module, for example as a hot plug detect signal, or through the secondary interface module, for example as incoming auxiliary audio and data.

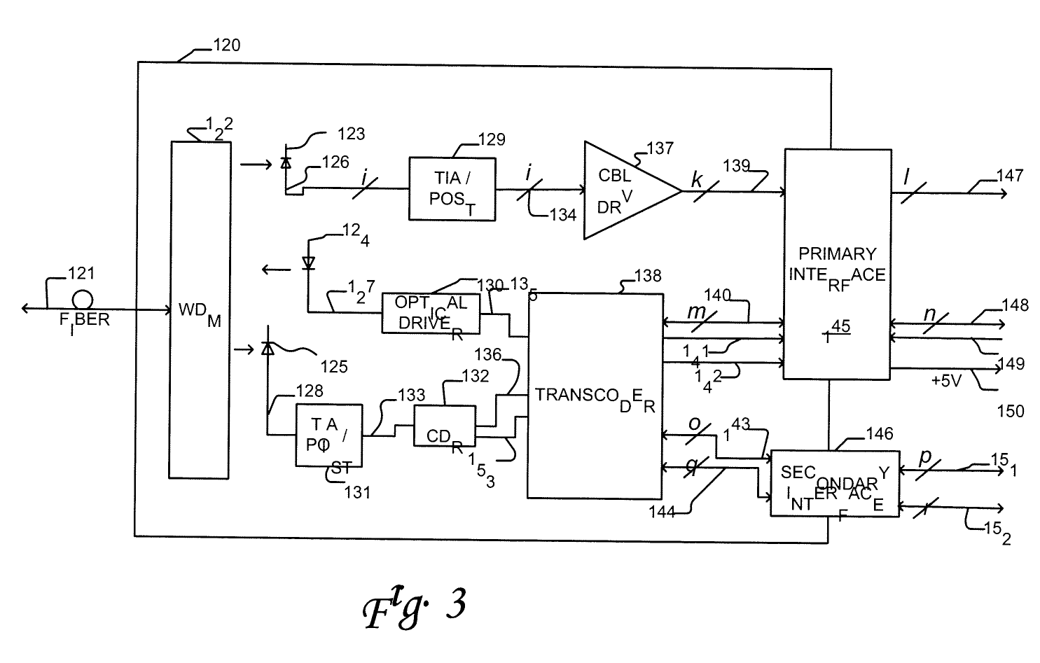

FIG. 3 depicts an example receiving module configured to receive a wavelength multiplexed encoded signal from a transmitter, to demultiplex and decode the signal into a plurality of signals and to provide the signals through an interface. In some example system implementations, receiving module 120 may be configured to communicate with a transmitting module as described above. Receiving module 120 may comprise a fiber optic line 121 optically coupled to a WDM demultiplexer/multiplexer 122. WDM 122 may be configured to optically demultiplex an incoming signal from the optic line into a plurality of video signals and a single encoded signal. As discussed above regarding the example transmitter, WDM may comprise, for example, a arrayed waveguide filter used to separate an incoming wavelength multiplexed signal into the constituent wavelengths. WDM may be further optically coupled to a receiving photodiode 123 configured to convert optical signals into current modulated signals. In some examples, receiving photodiodes 123 are configured to activate only upon receipt of a certain wavelength of light. In other examples, optical filters, such as tunable optical filters (not shown) may be used to provide only the appropriate wavelengths to the appropriate receiving photodiodes.

The current modulated signals may be transmitted along plurality of i lines 126 electrically coupled to transimpedance amplifier 129. Transimpedance amplifier 129 may be configured to convert the current modulated signals into voltage modulated signals. In other examples, the i lines require different modulation or conditioning, and so a plurality of appropriately chosen transimpedance amplifiers may be used. Transimpedance amplifier 129 may be electrically coupled to a driver 137 by a plurality of i electrical lines 134. Driver 137 may be configured to condition electrical signals carried on lines 134 for use in a data receiver. Particularly, driver 137 may condition a plurality of video signals carried on line 134 so that the signals are substantially identical to video signals initially received by a receiver, as discussed above regarding FIG. 2. In examples configured to transmit a plurality of different types of signals from a plurality of different types of inputs and outputs, a corresponding plurality of drivers 137 may be chosen to appropriately condition the signal for the appropriate output.

The plurality of i electrical lines 139 may be coupled to a primary interface module 145. Primary interface module 145 may be configured to interface with a data cable by way of a variety of interfaces, for example, without limitation: a high definition multimedia interface (HDMI); a digital video interface (DVI); or a display port (DP) interface. In further examples, primary interface module 145 may be configured to have a plurality of ports, allowing the receiving module 120 to be configured to communicate with multiple devices as needed. For example, the primary interface module might have both a DVI and an HDMI port. In some these examples, k, the number of lines 139 may be different than l, the number of video output lines 147. For example, the transmitting module 120 may be used to transmit to a black and white only display through video output 147, in which case l would be less than k. In these examples, primary interface 145 may be configured to output appropriate signals to an appropriate subset of available output lines as needed. In these examples, electrical signals carried on these lines 139 may be conditioned by driver 137 so that a video receiving device coupled to the HDMI cable will not be able to detect the existence of a receiver and transmitter between it an a data creating device.

Referring still to FIG. 3, WDM 122 may be further optically coupled to receiving photodiode 125. WDM 122 may be configured to provide the signal for receipt by photodiode 125 as discussed above, for example through the use of arrayed wavelength gratings and tunable optical filters. Photodiode 125 may be configured to translate an optical signal into a current modulated electrical signal and to transmit this signal along electrical line 128. Electrical line 128 may be further coupled to transimpedance amplifier 131 configured to convert the current modulated signal into a voltage modulated signal. Transimpedance amplifier 131 may be electrically coupled to a clock recovery module 132 by electrical line 133. Clock recovery module 132 may be configured to recover a clock signal from an signal encoded with a clock signal and a data signal transmitted on line 133, for example using a digital phase lock loop or phase lock loop. Clock recovery module 132 may be electrically coupled to transcoder 138 by way of electrical lines 136 and 153. Clock recovery module 132 may transmit the recovered clock signal along line 153 and the remaining data signal along line 136 to transcoder 138.

Transcoder 138 may be configured to recover a plurality of data signals from the transmitted data signal. For example, transcoder 138 may use the recovered clock signal to perform time division multiplexing on the data signal carried on line 136 to recover a plurality of decoded data signals. In video and data transmission applications, the decoded data signals may comprise, for example: digital data channel signals, a hot plug detect signal, a plurality of auxiliary data signals, a high-bandwidth digital content protection (HDCP) signal, and a plurality of auxiliary audio signals. Transcoder 138 may be further coupled to primary interface 145 and secondary interface 146 by way of plurality of lines 140, lines 141 and 142, and pluralities of lines 143 and 144. Transcoder 138 may be further configured to provide the decoded data signals to various lines. For example, transcoder 138 may provide: the digital display channel signals and the HDCP signal, along line 140; the auxiliary data signals along line 143; and the auxiliary audio signals along line 144. In examples allowing for multiple output ports, the number m of available output lines 140 may be greater than the number n of needed output lines 148. For example, n may be large enough to accommodate a CEC channel, which is not used by a DVI interface. In which case, the transcoder 138 or the interface 145 may be configured to utilize only those lines that are needed for the particular application. Transcoder 138 may be further configured to provide a voltage along line 142 to power a data displaying or receiving device. For example, transcoder 138 may provide +5V along line 142. Transcoder 138 may be further electrically coupled to a plurality of outgoing signal lines.

Plurality of lines 140 may have outgoing line components, for example, outgoing signals for handshaking purposes may be transmitted along lines 140. In further examples, line 141 may represent an outgoing hot plug detect line and pluralities of lines 143 and 144 may have outgoing components. In these examples, transcoder 138 may be configured to multiplex these outgoing signals into one combined outgoing signal, for example, through time division multiplexing. Transcoder 138 may be further coupled to outgoing line 135 to which it provides the combined signal. Outgoing line 135 may be electrically coupled to an optical driver 130 to enable optical transmission of signals. Optical driver may 130 may be coupled to line 127, which provides the optically driven signals to transmitting laser or light emitting diodes 124. Laser or light emitting diode 124 may be a VSCEL laser emitting diode and be in optical communication with WDM 122 using tunable optical filters and arrayed waveguide gratings, as discussed above. WDM 122 may transmit the outgoing signal along fiber 121.

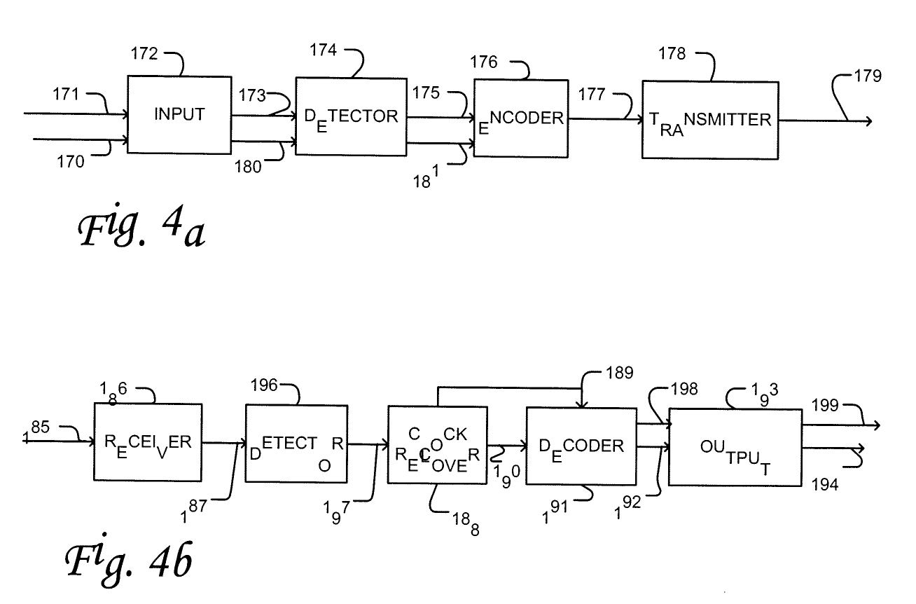

Referring now to FIG. 4A, FIG. 4A represents a functional block diagram of an example implementation of the present invention in a transmitting capacity. Input module 172 may be coupled to data line 171 and clock line 170. For example, input module 172 may be a primary or secondary interface, as described regarding FIG. 2. Input module 172 may be configured to provide a received data signal along line 173 to detector module 174, and a received clock signal to detector module 174 along line 180. Detector module 174 may be coupled to encoder module 176 by way of lines 175 and 181. Detector module 174 may be configured to provide a data signal to encoder module 176 through line 175 and to provide the clock signal through line 181. Encoder module 176 may be configured to combine the data signal and the clock signal into a single outgoing signal in such a way that enables clock and data recovery at a receiving location. Encoder module 176 may be further configured so that the combination is performed so that cross talk or other introduction of signal noise does not prevent the clock and data recovery. For example, detector module 174 and encoder module 176 may constitute module components of a transcoder module as described regarding FIG. 2. Encoder module 176 may be coupled to transmitter module 178 through line 177. Encoder module may provide the combined signal to transmitter module 178 along line 177. Transmitter module 178 may be configured to transmit the encoded and combined signal along line 179. For example, transmitter module may comprise a WDM as described regarding FIG. 2.

Referring now to FIG. 4B, FIG. 4B represents a functional block diagram of an example implementation of the present invention in a receiving capacity. Receiver module 186 may be configured to receive an incoming encoded signal along line 185. For example, receiver module 186 might comprise a WDM and line 185 might comprise a fiber, as described regarding FIG. 3. Receiver module 186 may be further configured to provide the received incoming encoded signal along line 187 to detector module 188. Detector module 188 may be configured to provide a received and detected signal to clock recovery module 188 along line 197. For example, detector module might comprise a transimpedence amplifier of the type described regarding FIG. 3. Clock recovery module 188 may be configured to provide the recovered clock signal along line 189 to decoder module 191. Clock recovery module 188 may be further configured to provide the recovered data signal along line 190 to decoder module 191. For example, clock recovery module 188 might comprise a clock recovery device as described regarding FIG. 3. Decoder module 191 may be configured to utilized the clock signal from line 189 to decode the data signal from line 190 and to convert the data signal into a non-return to zero line code signal. For example, decoder module 191 might comprise a transcoder as described regarding FIG. 3. Decoder module 191 may be further configured to provide the clock signal to output module 193 along line 198 and to provide the converted data signal to output module 193 along line 192. output module 193 may be configured to output the converted data signal along line 194 and the clock signal along line 199 for further downstream use. For example, output module 193 might comprise a primary or secondary interface as described regarding FIG. 3.

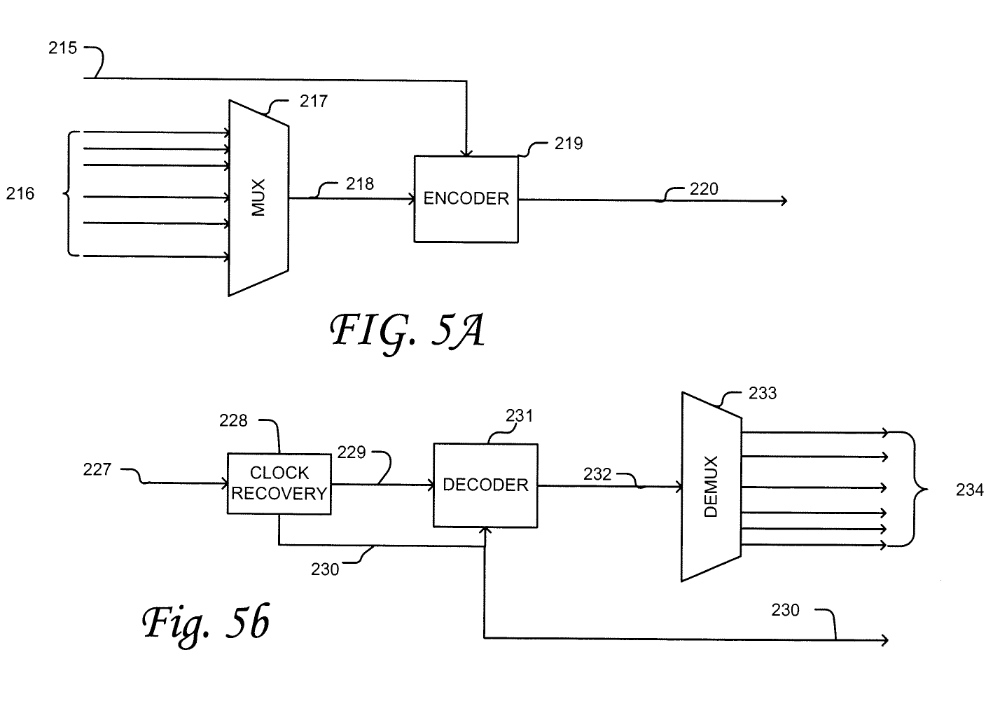

Referring now to FIG. 5A, FIG. 5A represents a functional block diagram of an example implementation of the invention in a transmitting capacity, for example, in the transcoder 81 of FIG. 2 or transcoder 138 of FIG. 3. Multiplexing module 217 may be configured to combine signals received from a plurality of lines 216 and to provide the combined signal on line 218 to encoder module 219. Encoder module 219 may be configured to provide a signal conditioned for transmission along line 220, which encodes the combined signal received from line 218 with a clock signal received from line 215. Encoder module 219 may be configured to perform this encoding such that clock and data recovery are enabled and the effects of signal noise introduction are mitigated. Encoder module 219 may then transmit the encoded signal along line 220.

Referring now to FIG. 5B, FIG. 5B represents an alternate example implementation of the invention in a receiving capacity, for example in the transcoder 81 of FIG. 2 or transcoder 138 of FIG. 3. Clock recovery module 225 may be configured to perform clock and data recovery from an incoming signal. Clock recovery module may be coupled to incoming line 227 and may provide a recovered clock signal to decoder module 231 through line 230 and may provide a recovered data signal to decoder module 231 through line 229. Decoder module 231 may be configured to perform signal decoding or transcoding. Decoder module 231 may be further configured to decode the data signal provided through line 229 utilizing the clock signal provided in line 230. Decoder module 231 may be further configured to convert the data signal into a format suitable for demultiplexing by demultiplexer module 233. Demultiplexer module 233 may be configured to form a plurality of signals from one multiplexed data signal. Demultiplexer module 233 may be further configured to provide a plurality of data signals along plurality of data lines 234. In some example implementations, the signal incoming on line 227 is a signal that was transmitted by an encoder according to the discussion of FIG. 5A. In these examples the signals provided on plurality of lines 234 may be substantially identical to the signals received from plurality of lines 216 in FIG. 5A.

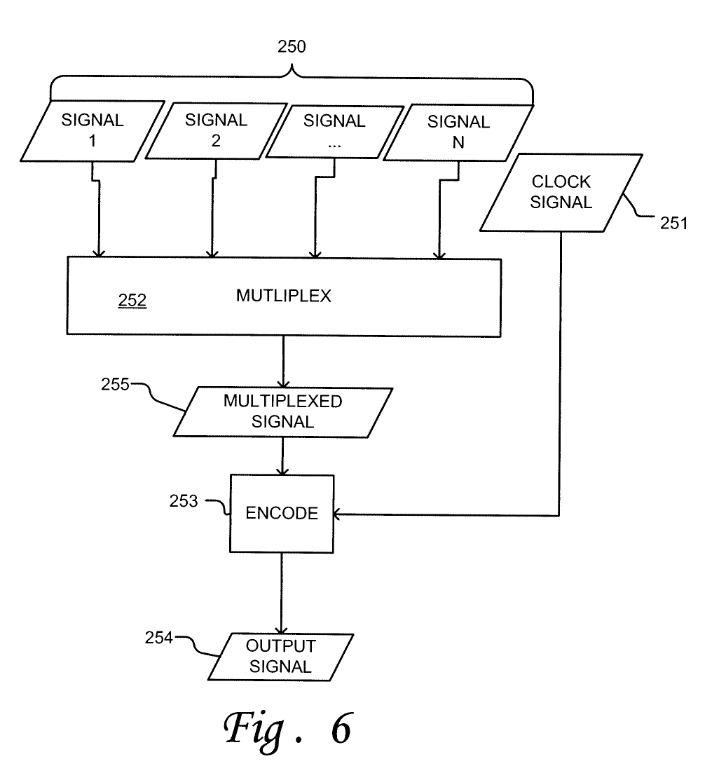

Referring now to FIG. 6, FIG. 6 represents a flow chart of an example method of the current invention in a transmitting capacity. First, a plurality of signals are provided. The plurality of signals may comprise data signals 250, and clock signal 251. In step 2, the plurality of signals 250 are multiplexed 252 to form one multiplexed signal 255. The multiplexing step 252 may comprise any process or method used to combine a plurality of signals into one signal. For example, without limitation, multiplexing step 252 may comprise time division multiplexing. Next, multiplexed signal 255 is combined with clock signal 251 in encoding step 253 to form output signal 254. Encoding step 253 may represent any method or process for combining a data signal with a clock signal in such a way that clock and data recovery are enabled at a downstream location.

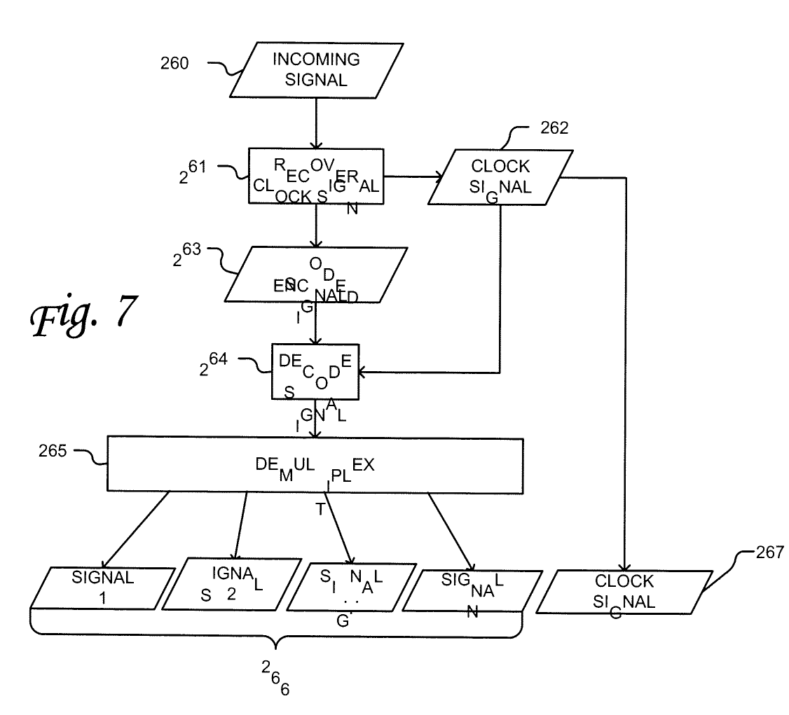

Referring now to FIG. 7, FIG. 7 represents a flow chart of an example implementation of the invention in a receiving capacity. First, incoming signal 260 is received. Next, in recover clock signal step 261, clock signal 262 and encoded signal 263 are recovered. Next, encoded data signal 263 is decoded using clock signal 262 in decoding step 264 to decode or translate the incoming line code into a different line code format suitable for data demultiplexing. Next, in demultiplexing step 265, the decoded signal is demultiplexed to form plurality of outgoing data signals 266. Demultiplexing step 265 may comprise, for example, time division demultiplexing. In certain examples, incoming signal 260 is substantially identical to output signal 254 discussed regarding FIG. 6. In these examples, output signals 266 and clock signal 267 may be substantially identical to input signals 250 and clock signal 251 illustrated in FIG. 6.

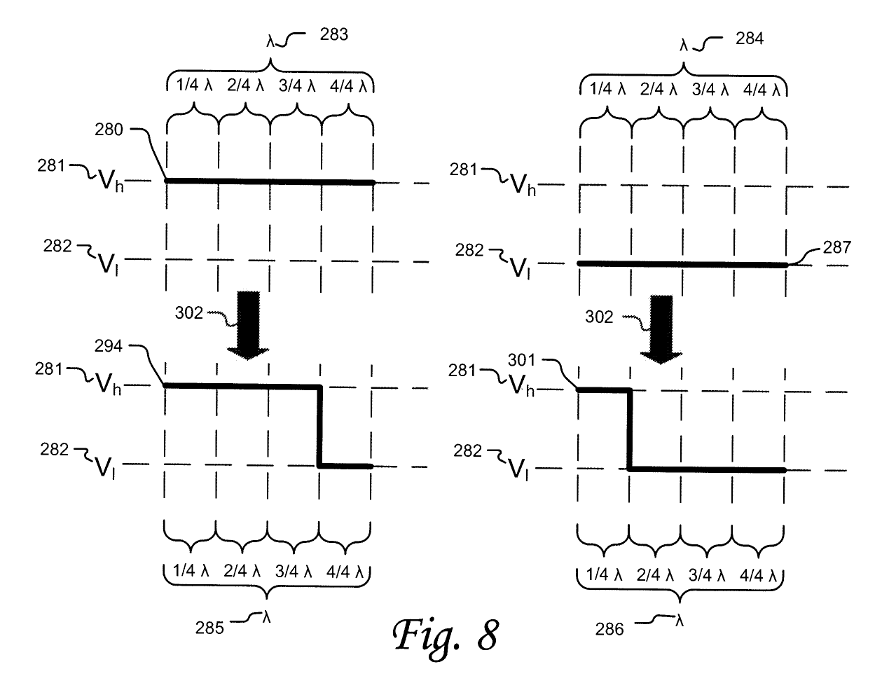

Referring now to FIG. 8, an example of a line code transcoding function is illustrated. Line code 280 may represent a logical “1” encoded according to a standard non-return-to-zero bipolar line code where “1” is encoded as a positive voltage 281 for the entirety of a wavelength 283. The transcoding function 302 may be configured to encode the logical “1” 280 as a waveform 294 with a “three-on-one-off” modulation. Under this example encoding, logical “1” waveform 294 has a duty cycle of 75%, i.e., it remains at a high voltage 281 for 75% of a wavelength 285 and transitions to a low voltage 282 for the remaining 25% of the wavelength 285.

Line code 287 may represent a logical “0” encoded according to the same standard non-return-to-zero bipolar line code, where “0” is encoded as a low voltage 282 for the entirety of a wavelength 284. In this example, transcoding function 302 may be configured to encode the logical “0” 287 as waveform 301. Under this example encoding, logical “0” waveform 301 has a 25% duty cycle, i.e. it remains at a high voltage 281 for the first 25% of a wavelength 286 and remains at a low voltage 282 for the remaining 75% of the wavelength 286. In other examples, encoding function 302 may operate on different domains of line codes and may produce different ranges of line codes, for example, the encoding function may operate on a Manchester encoded line code to produce a “1” waveform with a ⅔ duty cycle and a “0” waveform with a ⅓ duty cycle.

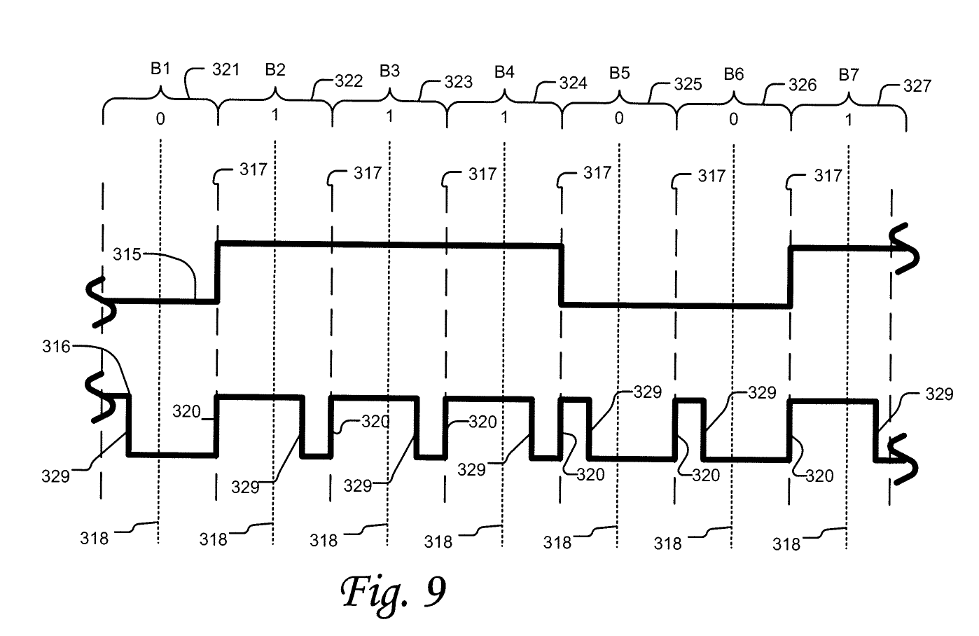

Referring now to FIG. 9, a portion of an example input signal 315 and an example portion output transcoded signal 316 are illustrated for comparison purposes. In the illustrated example, the signals correspond to the binary number 0111001. Input signal 315 may be encoded as described above according to a bipolar non-return-to-zero line code. Output signal 316 may be formed from input line code 315 according to an encoding function as described above, implemented using any tool known in the art to perform line code encoding or transcoding. As illustrated, there is no voltage transition between bits having the same state in the incoming signal 315. For example, the voltage remains high between B₂ 322, B₃ 323, and B₄ 324, corresponding to the signal portion “111.” Accordingly, data recovery can be difficult if the signal 315 is not accompanied by a corresponding clock signal. Clock recovery can be difficult because a long string of 1's or 0's does not provide the transitions needed for clock synchronization. However, as illustrated, there is a voltage transition 320 from a low voltage to a high voltage at the end of each bit of signal 316. Accordingly, signal 316 enables clock recovery. This clock signal is illustrated as a series of dashed lines 317 in FIG. 9 corresponding to up transitions 320. In this example, data recovery may be performed according to a signal sampling process at sampling times 318. As illustrated, sampling times 318 take place substantially in the center of the bit wavelengths. The duty cycle of the signal 316 is adjusted to allow for these sampling times. As illustrated, each “1” bit has a duty cycle of 75% with the first 75% of the wavelength being maintained at the high voltage, while each “0” bit has a duty cycle of 25% with the first 25% of the wavelength maintained at the low voltage. Therefore, at sampling times 318 each “1” is at the high voltage and each “0” is at the low voltage. Moreover, each bit nominally has at least 25% of a pulse length leading and trailing the sampling time at the high or low voltage, respectively. In environments with high crosstalk, noise manifests jitter, which affects the transition times of the signal pulses. The leading and trailing pulse length allows for continued data recovery because crosstalk noise does not substantially impact the voltage levels of the sampling locations 318. In other examples, different pulse lengths or duty cycles may be used. For example, the signal pulse length for a “1” bit might vary between approximately 65% and approximately 85%, and, correspondingly, the signal pulse length for a “0” might vary between approximately 15% and 35%. In other examples, the bit waveforms may be inverted with a high voltage corresponding to a “0” and a low voltage corresponding to a “1”.

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality. After reading this description, it will become apparent to a person skilled in the relevant art how to implement the invention using other computing modules or architectures.

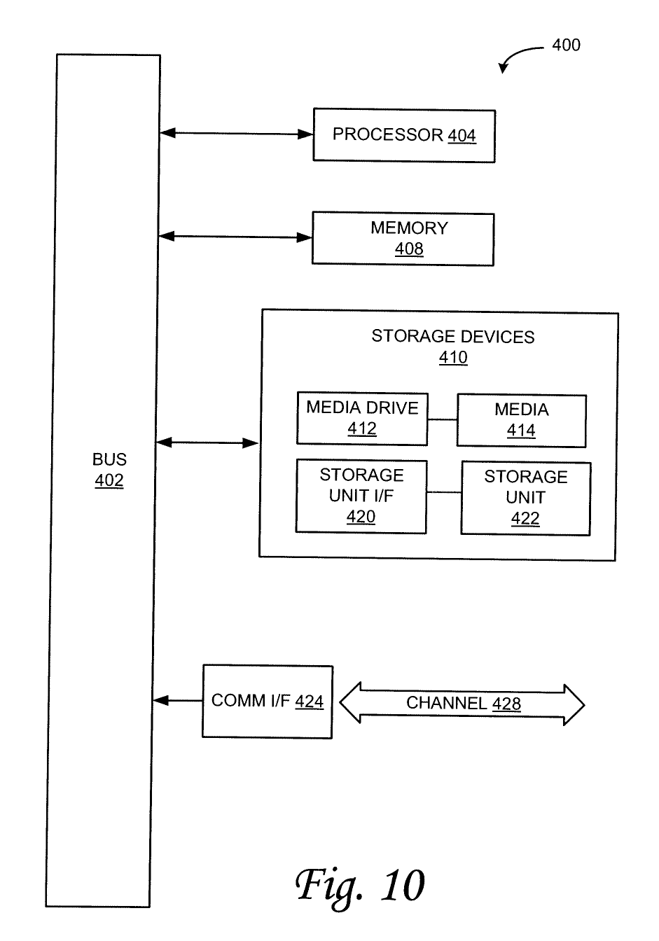

It will be apparent to a person skilled in the relevant art how to implement various features of the invention using software. For example, various features of the invention may be implemented using digital signal processing software. Where components or modules of the invention are implemented in whole or in part using software, in one embodiment, these software elements can be implemented to operate with a computing or processing module capable of carrying out the functionality described with respect thereto. One such example-computing module is shown in FIG. 10. Various embodiments are described in terms of this example-computing module 400. After reading this description, it will become apparent to a person skilled in the relevant art how to implement the invention using other computing modules or architectures.

Referring now to FIG. 10, computing module 400 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 400 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 400 might include, for example, one or more processors, controllers, control modules, or other processing devices, such as a processor 404. Processor 404 might be implemented using a general-purpose or special-purpose processing engine such as, for example, a microprocessor, controller, or other control logic. In the example illustrated in FIG. 10, processor 404 is connected to a bus 402, although any communication medium can be used to facilitate interaction with other components of computing module 400 or to communicate externally.

Computing module 400 might also include one or more memory modules, simply referred to herein as main memory 408. For example, preferably random access memory (RAM) or other dynamic memory, might be used for storing information and instructions to be executed by processor 404. Main memory 408 might also be used for storing temporary variables or other intermediate information during execution of instructions to be executed by processor 404. Computing module 400 might likewise include a read only memory (“ROM”) or other static storage device coupled to bus 402 for storing static information and instructions for processor 404.

The computing module 400 might also include one or more various forms of information storage mechanism 410, which might include, for example, a media drive 412 and a storage unit interface 420. The media drive 412 might include a drive or other mechanism to support fixed or removable storage media 414. For example, a hard disk drive, a floppy disk drive, a magnetic tape drive, an optical disk drive, a CD or DVD drive (R or RW), or other removable or fixed media drive might be provided. Accordingly, storage media 414, might include, for example, a hard disk, a floppy disk, magnetic tape, cartridge, optical disk, a CD or DVD, or other fixed or removable medium that is read by, written to or accessed by media drive 412. As these examples illustrate, the storage media 414 can include a computer usable storage medium having stored therein computer software or data.

In alternative embodiments, information storage mechanism 410 might include other similar instrumentalities for allowing computer programs or other instructions or data to be loaded into computing module 400. Such instrumentalities might include, for example, a fixed or removable storage unit 422 and an interface 420. Examples of such storage units 422 and interfaces 420 can include a program cartridge and cartridge interface, a removable memory (for example, a flash memory or other removable memory module) and memory slot, a PCMCIA slot and card, and other fixed or removable storage units 422 and interfaces 420 that allow software and data to be transferred from the storage unit 422 to computing module 400.

Computing module 400 might also include a communications interface 424. Communications interface 424 might be used to allow software and data to be transferred between computing module 400 and external devices. Examples of communications interface 424 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 424 might typically be carried on signals, which can be electronic, electromagnetic (which includes optical) or other signals capable of being exchanged by a given communications interface 424. These signals might be provided to communications interface 424 via a channel 428. This channel 428 might carry signals and might be implemented using a wired or wireless communication medium. These signals can deliver the software and data from memory or other storage medium in one computing system to memory or other storage medium in computing system 400. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to physical storage media such as, for example, memory 408, storage unit 420, and media 414. These and other various forms of computer program media or computer usable media may be involved in storing one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 400 to perform features or functions of the present invention as discussed herein.

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality. After reading this description, it will become apparent to a person skilled in the relevant art how to implement the invention using other computing modules or architectures.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A data transmission apparatus, comprising:
an input configured to receive a signal containing binary information;
an encoder coupled to the receiver, configured to produce a modulated signal containing the binary information; and
a transmitter coupled to the encoder, configured to transmit the modulated signal;
wherein the encoder encodes the modulated signal such that: a first state of the binary information comprises a waveform with a duty cycle strictly between 50% and 100%;
and a second state of the binary information comprises a waveform with a duty cycle strictly between 0% and 50%.

2. The apparatus of claim 1, wherein the first state comprises a waveform having a duty cycle between approximately 65% and approximately 85% and the second state comprises a waveform having a duty cycle between approximately 15% and 35%.

3. The apparatus of claim 1, wherein the waveform of the second state is an inverse of the waveform of the first state.

4. The apparatus of claim 2, wherein the modulated signal has a frequency substantially synchronized with a clock signal.

5. The apparatus of claim 1, wherein the modulated signal is configured to enable recovery of the clock signal at a clock signal recovery device.

6. The apparatus of claim 5, further comprising,
a multiplexer coupled to the transmitter, configured to:
receive a plurality of signals containing binary information;
combine the signals into a single signal; and
provide the single signal to the encoder.

7. The apparatus of claim 4, wherein the first state comprises a waveform having a duty cycle between approximately 65% and approximately 85% and the second state comprises a waveform having a duty cycle between approximately 15% and 35%.

8. The apparatus of claim 7, wherein the waveform of the second state is an inverse of the waveform of the first state.

9. A system for data transmission, comprising:
a transmitter and a receiver in communication,
wherein the transmitter is configured to:
receive a first data signal;
encode information contained in the first data signal in a second data signal; and
transmit the second data signal to the receiver; and
wherein the receiver is configured to:
receive the second data signal;
decode information contained in the second data signal;
wherein the second data signal is encoded with binary information, having:
a first state of the binary data comprising a waveform with a duty cycle strictly between 50% and 100%; and
a second state of the binary data comprising a waveform with a duty cycle strictly between 0% and 50%.

10. The system of claim 9,
wherein the transmitter is further configured to:
receive a plurality of high bandwidth data signals;
receive a plurality of low bandwidth data signals;
receive a clock signal;
combine the plurality of low bandwidth data signals and the clock signal to form the first data signal; and
transmit the plurality of high bandwidth data signals to the receiver; and
wherein the receiver is further configured to:
receive the plurality of high bandwidth data signals;
and wherein the decoding comprises recovering the clock signal and the plurality of low bandwidth data signals.

11. The system of claim 10, wherein the plurality of high bandwidth data signals comprise the video portion of a high definition audiovisual transmission and the plurality of low bandwidth data signals comprise the non-video portion of a high definition audiovisual transmission.

12. The system of claim 11, wherein the first state of binary data comprises a waveform having approximately a 75% duty cycle and the second state of binary data comprises a waveform having approximately a 25% duty cycle.

13. The system of claim 12 wherein:
the first state of binary data further comprises a waveform having:
an initial pulse length at a first voltage, the initial pulse length comprising approximately 75% of the waveform wavelength; and
a subsequent pulse length at a second voltage, the subsequent pulse length comprising approximately 25% of the waveform wavelength; and
the second state of binary data further comprises a waveform having:
an initial pulse length at a first voltage, the initial pulse length comprising approximately 25% of the waveform wavelength; and
a subsequent pulse length at a second voltage, the subsequent pulse length comprising approximately 75% of the waveform wavelength.

14. The system of claim 13, further comprising:
a transmitter interface configured to receive the plurality of high bandwidth data signals, the plurality of low bandwidth data signals, and the clock signal, from an audiovisual data cable, the transmitter interface further configured to provide the signals to the transmitter; and
a receiver interface configured to receive the plurality of high bandwidth data signals, the plurality of low bandwidth data signals, and the clock signal, from the receiver, the receiver interface further configured to provide the signals to an audiovisual data cable.

15. The system of claim 13, wherein the transmitter transmits the second data signal and the plurality of high bandwidth data signals along an optical fiber.

16. The system of claim 11, wherein the high definition audiovisual transmission is obtained through a high-definition multimedia interface.

17. The system of claim 11, wherein the high definition audiovisual transmission is obtained through a digital visual interface.

18. The system of claim 11, wherein the high definition audiovisual transmission is obtained through a display port interface.

19. A computer program product for controlling a data transmission apparatus, the computer program product comprising a computer-readable storage medium having computer-readable program code embodied in said medium, the computer-readable program code comprising:
a first executable portion for receiving a signal containing binary information;
a second executable portion for recovering the binary information from the signal;
a third executable portion for producing a modulated signal containing the binary information, wherein the encoder encodes the binary information in the modulated signal such that: a first state of the binary information comprises a waveform with a duty cycle strictly between 50% and 100% and a second state of the binary information comprises a waveform with a duty cycle strictly between 0% and 50%; and
a fourth executable portion for transmitting the modulated signal.

20. A data receiving apparatus, comprising:
a receiver configured to receive a modulated signal containing binary information;
a decoder coupled to the receiver, configured to produce a decoded signal containing the binary information; and
an output coupled to the decoder, configured to transmit the decoded signal;
wherein the modulated signal is encoded such that: a first state of the binary information comprises a waveform with a duty cycle strictly between 50% and 100%;
and a second state of the binary information comprises a waveform with a duty cycle strictly between 0% and 50%.

21. The apparatus of claim 20, wherein the first state comprises a waveform having a duty cycle between approximately 65% and approximately 85% and the second state comprises a waveform having a duty cycle between approximately 15% and 35%.

22. The apparatus of claim 20, wherein the waveform of the second state is an inverse of the waveform of the first state.

23. The apparatus of claim 21, wherein the modulated signal has a frequency substantially synchronized with a clock signal.

24. The apparatus of claim 20, wherein the modulated signal has a frequency substantially synchronized with a clock signal.

25. The apparatus of claim 20, further comprising:
a clock recovery device coupled to the receiver to recover a clock signal from the modulated signal; wherein
the output is further configured to transmit the clock signal.

26. The apparatus of claim 6, further comprising,
a demultiplexer coupled to the receiver, configured to:
receive a single signal from decode;
divide the signal into a plurality of signals containing binary information.

27. The apparatus of claim 23, wherein the first state comprises a waveform having a duty cycle between approximately 65% and approximately 85% and the second state comprises a waveform having a duty cycle between approximately 15% and 35%.

28. The apparatus of claim 27, wherein the waveform of the second state is an inverse of the waveform of the first state.
